(19) United States
(12) Patent Application Publication
(10) Pub. No.: US 2014/0354431 A1
(43) Pub. Date: Dec. 4, 2014

(54) ELECTRONIC DEVICE AND ANTI THEFT METHOD FOR ELECTRONIC DEVICE

(71) Applicant: HON HAI PRECISION INDUSTRY CO., LTD., New Taipei (TW)

(72) Inventor: CHIA-HUEI LIN, New Taipei (TW)

(73) Assignee: HON HAI PRECISION INDUSTRY CO., LTD., New Taipei (TW)

(21) Appl. No.: 14/161,648

(22) Filed: Jan. 22, 2014

(30) Foreign Application Priority Data
May 30, 2013 (TW) 102119235

(51) Int. Cl. G08B 13/14

(52) U.S. Cl. CPC G08B 13/14
USPC 340/568.1

(57) ABSTRACT

An electronic device includes a main body and a transmitter. The main body includes a controller, a sensor, and an alarm controlled by the controller. The transmitter is connected to the main body. When the transmitter is removed from the main body, the controller is used to control an electronic device system of the main body in a locked state. When the electronic device system is in the locked state and the main body is moved, the sensor is used to inform the controller to turn on the alarm. When the alarm is turned on, the transmitter is connected to the main body, the sensor is used to inform the controller to turn off the alarm. The disclosure further offers an anti theft method for the electronic device.

### BACKGROUND

1. Technical Field

The present disclosure relates to an electronic device and an anti theft method for the electronic device.

2. Description of Related Art

An electronic device, such as a note book, is a popular product that is often stolen. To prevent the electronic device from theft, a specialized lock is used to lock the electronic device. However, the specialized lock is expensive. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like-reference numerals designate corresponding parts throughout the several views.

FIG. 1 is an exploded, isometric view of an embodiment of an electronic device.

FIG. 2 is an assembled view of the electronic device of FIG. 1.

FIG. 3 is similar to FIG. 2, but viewed from a different aspect.

FIG. 4 is a block diagram of the electronic device of FIG. 1.

FIG. 5 is a flowchart of an anti theft method for the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

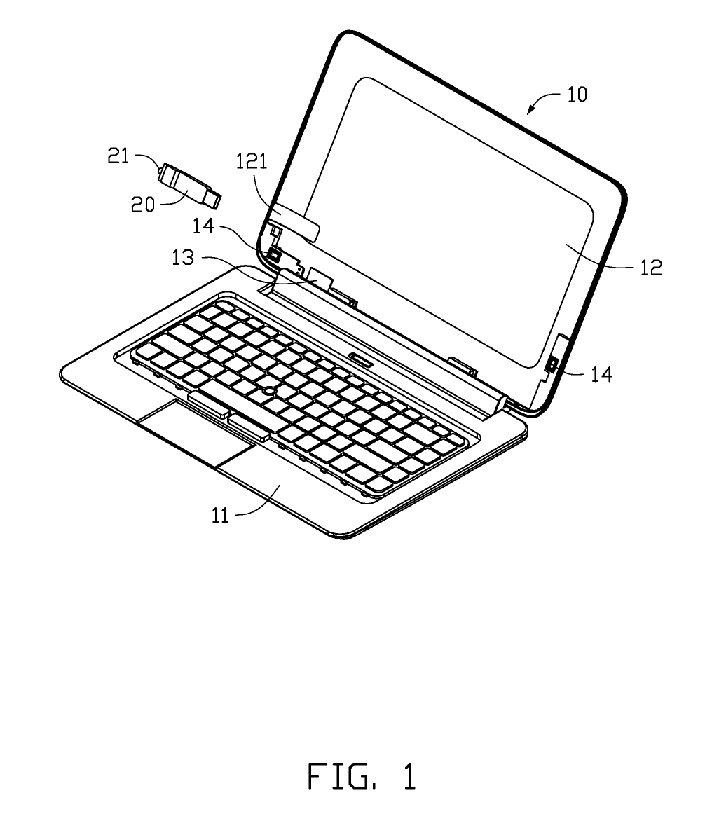

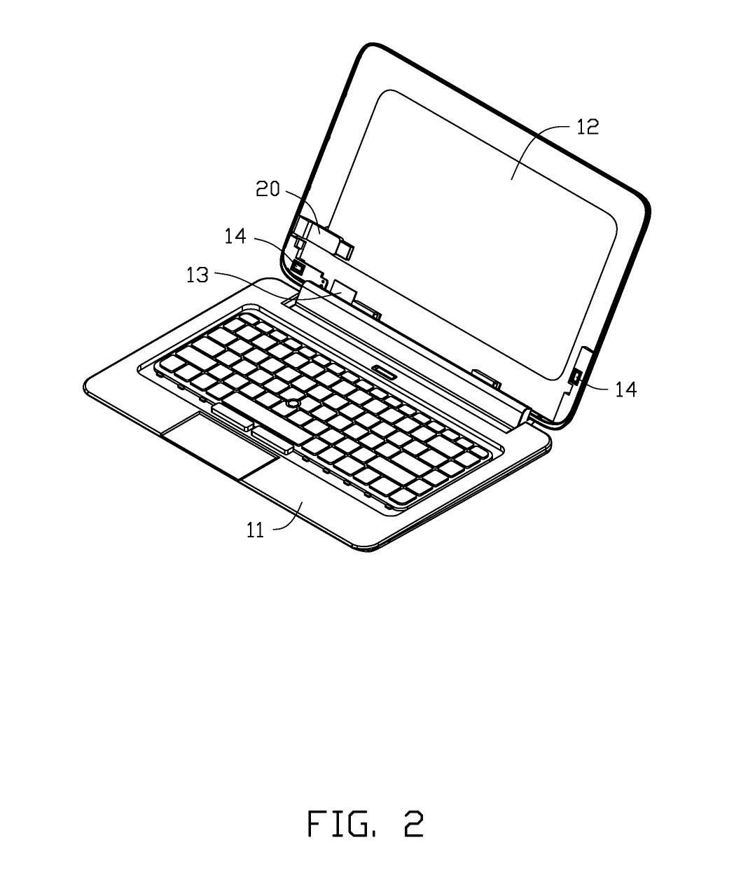

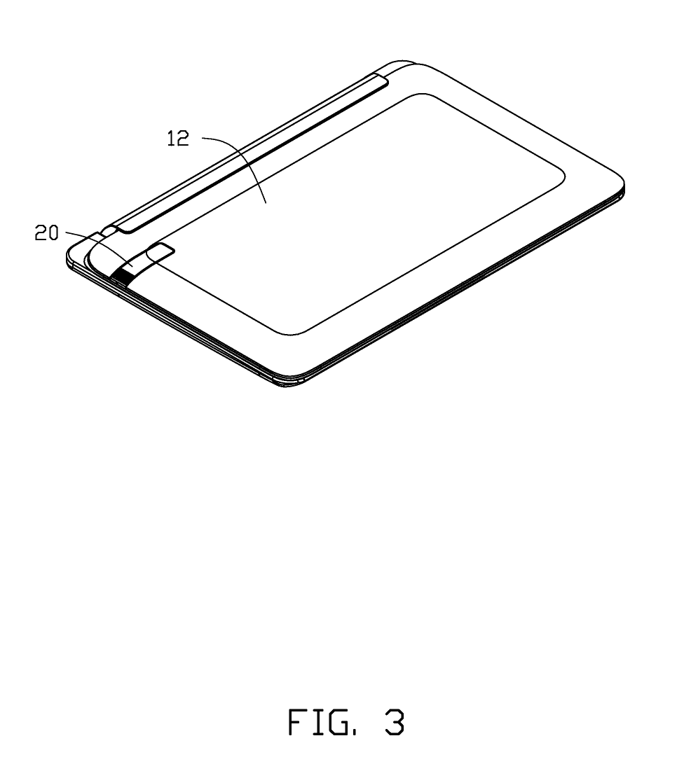

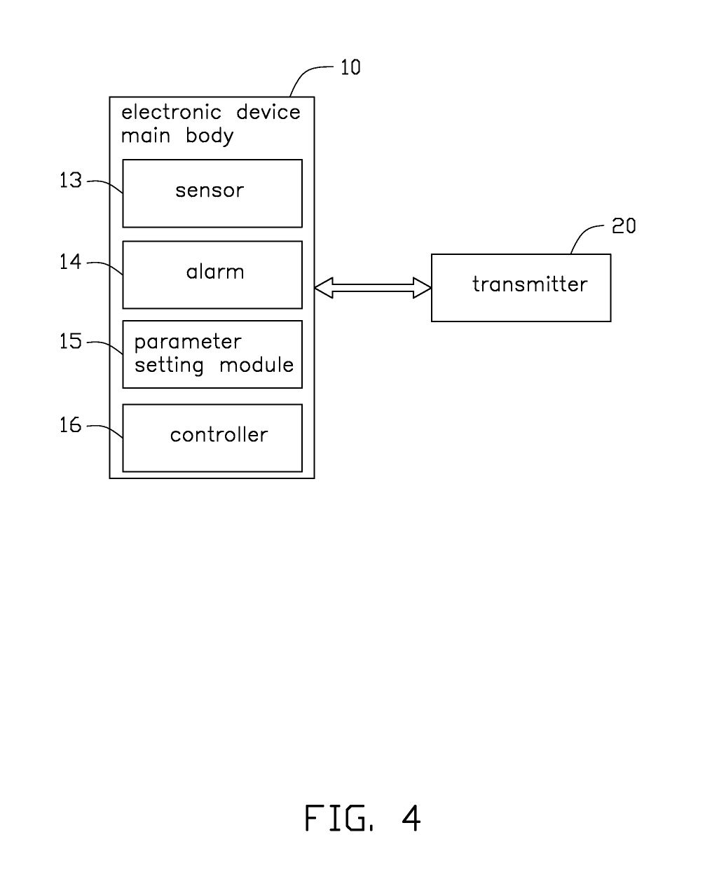

FIGS. 1-4 illustrate an embodiment of an electronic device. The electronic device comprises a main body 10 and a transmitter 20 connected to the main body 10.

The main body 10 comprises a base 11, a display 12 rotatably attached to the base 11, a sensor 13, and two alarms 14 secured to the display 12. A parameter setting module 15 and a controller 16 are located in the main body 10. In one embodiment, the electronic device is a notebook computer, a PC computer or other electronic device, and each alarm 14 is a speaker. The sensor 13 is an acceleration meter.

The display 12 defines an inserting slot 121. The sensor 13 is secured to the display 12 and adjacent to the base 11. The sensor 13 is used to detect whether the main body 10 is violated, such as the main body 10 is moved. In one embodiment, the sensor 13 is an accelerometer. That is, when the main body 10 is in an immobile state or is moved uniformly, the sensor 13 will not work. When the main body 10 begins to accelerate, the sensor 13 will function.

The parameter setting module 15 is used to set a sensitivity of the senor 13, a ringing volume and a ringing type of the alarm 14, a stop time of the alarm 14, for example, when the sensor 13 senses the main body 10 stop accelerating, the alarm 14 stops sounding. The controller 16 is used to control an electronic device system of the electronic device entering into a locked state, when the transmitter 20 is removed from the main body 10. The controller 16 is further used to receive a signal from the sensor 13 to turn on the alarm 14, or turn off the alarm 14 when the transmitter 20 is inserted into the inserting slot 121. In one embodiment, the transmitter 20 is connected wirelessly to the main body 10. The transmitter 20 is a portable wireless transmitter 20. That is, when the transmitter 20 is removed from the inserting slot 121, the electronic device system of the electronic device is in a locked state, and when the transmitter 20 is inserted into the inserting slot 121, the electronic device system of the electronic device is in an unlocked state.

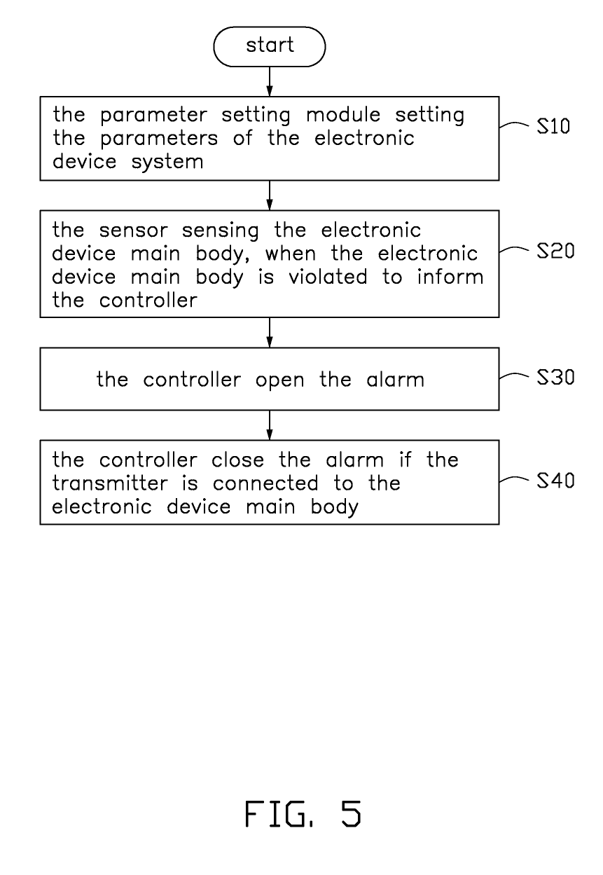

FIG. 5 illustrates an embodiment of an anti theft method for the electronic device. The method comprises the following steps:

S10: the sensitivity of the senor 13, the ringing volume and a ringing type of the alarm 14, a stopping time of the alarm 14 are set by the parameter setting module 15.

S20: when the transmitter 20 is inserted into the inserting slot 121, the controller 16 detects that the transmitter 20 is inserted into the inserting slot 121 to control the electronic device system in the unlocked state. When the transmitter 20 is removed from the inserting slot 121, the controller 16 detects that the transmitter 20 is removed from the inserting slot 121 and controls the electronic device system in the locked state. When the electronic device system is in the locked state, if the sensor 13 senses the main body 10 begin to accelerate, the sensor 13 sends a signal to the controller 16.

S30: the controller 16 receives the signal from the sensor 13 and opens the alarm 14, so that the alarm 14 informs that the main body 10 has been moved. Simultaneously, the electronic device system can send a message of the movement of the main body 10 to the transmitter 20, and the user/owner of the electronic device can know the main body 10 has moved.

S40: if the transmitter 20 is inserted back to the inserting slot 121 to open the electronic device system, and the controller 16 turns off the alarm 14.

In another embodiment, a remote-control unit 21 is secured to the transmitter 20. The remote-control unit 21 is connected to the controller 16 via infrared ray. To turn off the alarm 14 when the alarm 14 has been turned on, the remote-control unit 21 can send a signal to the controller 16. When the user takes the transmitter 20, and the main body 10 has been stolen, the electronic device system will be in a locked state. Thus, the data in the main body cannot be accessed.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An electronic device comprising:
a main body comprising a controller, a sensor, and an alarm controlled by the controller; and
a transmitter connected to the main body;
wherein when the transmitter is removed from the main body, the controller controls an electronic device system of the main body in a locked state; when the electronic device system is in the locked state and the main body is accelerated, the sensor informs the controller to turn on the alarm; and when the alarm is turned on, the transmitter is configured to be connected to the main body, to have the sensor inform the controller to turn off the alarm.

2. The electronic device of claim 1, wherein the sensor is an acceleration meter.

3. The electronic device of claim 1, wherein the transmitter comprises a remote-control unit connected to the controller, and the remote-control unit is configured to send a signal to the controller to turn off the alarm when the alarm is turned on.

4. The electronic device of claim 1, wherein the main body further comprises a parameter setting module, and the parameter setting module is configured to set parameters of the electronic device system.

5. The electronic device of claim 4, wherein the parameters comprises a sensitivity of the senor, a ringing volume and a ringing type of the alarm, and a stopping time of the alarm.

6. The electronic device of claim 1, wherein the main body further comprises a base and a display rotatably attached to the base, an inserting slot is defined in the display, and the transmitter is moveable inserted into the inserting slot.

7. The electronic device of claim 1, wherein the electronic device is a notebook computer.

8. An anti theft method for an electronic device comprising:
connecting a transmitter to a main body of the electronic device;
removing the transmitter from the main body and controlling an electronic device system of the main body into a locked state by a controller in the main body;
informing the controller by a sensor when the electronic device system is in the locked state and the main body is accelerated;
turning on an alarm by the controller; and
turning off the alarm by the controller when the transmitter is connected to the main body.

9. The anti theft method of claim 8, further comprising: setting parameters of the electronic device system by a parameter setting module, before connecting the transmitter to the main body.

10. The anti theft method of claim 9, wherein the parameters comprises a sensitivity of the senor, a ringing volume and a ringing type of the alarm, and a stopping time of the alarm.

11. The anti theft method of claim 8, wherein the sensor is an acceleration meter.

12. The anti theft method of claim 8, further comprising: sending a signal to the controller to turn off the alarm by a remote-control unit that is connected to the transmitter, after turning on the alarm.

13. The anti theft method of claim 8, wherein the electronic device is a note book.

14. The anti theft method of claim 13, wherein connecting the transmitter to the main body further comprising: inserting the transmitter into an inserting slot of a display of the note book, and connecting the transmitter to the main body by wireless network.
